(19) United States
(12) Patent Application Publication
(10) Pub. No.: US 2016/0019860 A1
(43) Pub. Date: Jan. 21, 2016

(54) DISPLAY APPARATUS, DISPLAY SYSTEM, DISPLAY METHOD, AND RECORDING MEDIUM

(71) Applicants: Hiroshi MAEDA, Kanagawa (JP); Reiji YUKUMOTO, Kanagawa (JP); Sachiko ABE, Tokyo (JP)

(72) Inventors: Hiroshi MAEDA, Kanagawa (JP); Reiji YUKUMOTO, Kanagawa (JP); Sachiko ABE, Tokyo (JP)

(73) Assignee: RICOH COMPANY, LTD., Tokyo (JP)

(21) Appl. No.: 14/741,275

(22) Filed: Jun. 16, 2015

(30) Foreign Application Priority Data
Jul. 16, 2014 (JP) 2014-145887

(51) Int. Cl. G09G 5/00; H04N 9/31; G06T 1/20; G09G 5/18

(52) U.S. Cl. CPC G09G 5/003; G09G 5/18; H04N 9/31; G06T 1/20

(57) ABSTRACT

Disclosed is a display apparatus communicating with a plurality of terminals. The display apparatus and the terminals are connected via a network. The display apparatus includes a communications connection establishing module configured to establish a plurality of communications connections with the terminals, a selection module configured to select a communications connection from the communications connections, a display controller configured to control a display based on a request from the selected one of the communications connections, a determination module configured to determine whether a part of the communications connections needs to be disconnected, and a communications disconnection module configured to disconnect the part of the communications connections based on a predetermined rule when the determination module determines that the part of the communications connections needs to be disconnected.

### BACKGROUND OF THE INVENTION

1. Field of the Invention

The disclosures discussed herein relate to a display apparatus, a display system, a display method, and a non-transitory recording medium storing a display program.

2. Description of the Related Art

In general, projectors are each provided with multiple interfaces. Further, projectors are configured to switch images to be output in accordance with requests from the bodies of the projectors or PCs (personal computers) connected via networks.

Japanese Laid-open Patent Publication No. 2013-142706 (hereinafter referred to as “Patent Document 1”), for example, discloses a technology to reserve projection requests when the projector receives output requests from multiple PCs in a received order of the projection requests based on a predetermined rule so as to switch images to be output in the received order of the projection requests.

However, the projector needs to maintain communications connections with the PCs or the like of the transmission sources of the images in order to project images by quickly switching the images in the received order of the projection requests.

However, the related art technology does not consider an upper limit of the number of communications connections allowed to be established when the projector receives the projection requests from the PCs connected via the network. Hence, the communications connections are maintained every time the projection requests are reserved. As a result, the resources for the communications connections of the projector may be depleted, failing to connect the PCs to the projector for the purpose of apparatus management of the projectors.

### RELATED ART DOCUMENT

### Patent Document

### Patent Document 1

Japanese Laid-open Patent Publication No. 2013-142706

### SUMMARY OF THE INVENTION

Accordingly, it is a general object in one embodiment of the present invention to provide a display apparatus, a display system, a display method, and a non-transitory recording medium storing a display program that are capable of communicating with multiple terminals in consideration of the number of communications connections, and that substantially obviate one or more problems caused by the limitations and disadvantages of the related art.

According to an aspect of embodiments, there is disclosed a display apparatus communicating with a plurality of terminals, the display apparatus and the terminals being connected via a network. The display apparatus includes a communications connection establishing module configured to establish a plurality of communications connections with the terminals; a selection module configured to select a communications connection from the communications connections; a display controller configured to control a display based on a request from the selected one of the communications connections; a determination module configured to determine whether a part of the communications connections needs to be disconnected; and a communications disconnection module configured to disconnect the part of the communications connections based on a predetermined rule when the determination module determines that the part of the communications connections needs to be disconnected.

Other objects, features and advantages of the present invention will become more apparent from the following detailed description when read in conjunction with the accompanying drawings.

### BRIEF DESCRIPTION OF THE DRAWINGS

FIG. 1 is a diagram illustrating a system configuration example of a display system;

FIG. 2 is a diagram illustrating a hardware configuration example of a projector;

FIG. 3 is a diagram illustrating a hardware configuration example of an information processing apparatus;

FIG. 4 is a diagram illustrating a functional configuration example of the display system;

FIG. 5 is a diagram illustrating an example of a list of process requests managed by a process request manager;

FIG. 6 is a diagram illustrating an example of a list of output requests managed by an output request manager;

FIG. 7 is a diagram illustrating an example of a management list of interfaces managed by an input switching part;

FIG. 8 is a sequence diagram illustrating a process of switching contents to be output along with switching the interface that inputs the contents;

FIG. 9 is a sequence diagram illustrating a process of switching the contents to be output along with ending the output of the contents;

FIG. 10 is a flowchart illustrating an example of a process of determining an output status of an output request;

FIG. 11 is a flowchart illustrating an example of a process of disconnecting communications connections when the number of maintained communications connections reaches the upper limit;

FIG. 12 is a diagram illustrating an example of a list of process requests managed by a process request manager in a modification 1;

FIG. 13 is a flowchart illustrating an example of a process of disconnecting communications connections in a modification 2;

FIG. 14 is an example when the upper limit is provided with respect to the number of the process requests added on the list of the output requests in a modification 3; and

FIGS. 15A and 15B are diagrams illustrating an example of a list of output requests provided for each of request contents in the modification 3.

### DETAILED DESCRIPTION OF THE PREFERRED EMBODIMENTS

In the following, a description is given of embodiments with reference to accompanying drawings.

### System Configuration

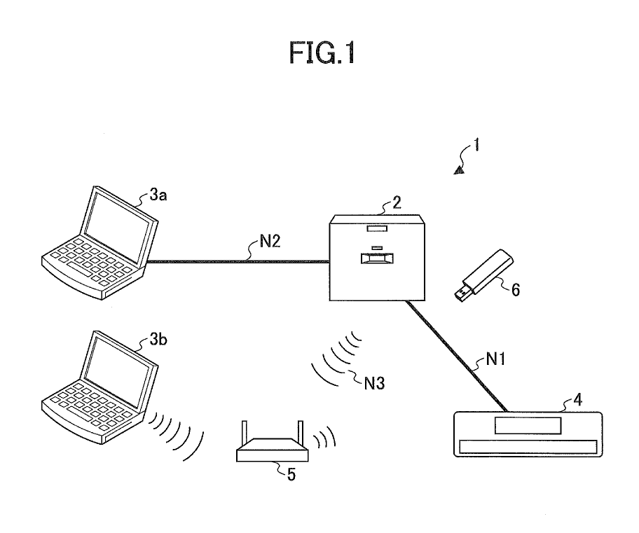

FIG. 1 is a diagram illustrating a system configuration example of a display system 1 of an embodiment. The display system 1 includes a projector 2, information processing apparatuses 3a, 3b, 3c, . . . (also generically called an “information processing apparatus 3”), and an image output apparatus 4. The projector 2 is connected to the image output apparatus 4 via a data transmission line N1. Further, the projector 2 is connected to the information processing apparatus 3a via a network N2 such as a LAN (Local Area Network). Similarly, the projector 2 is connected to the information processing apparatus 3b via a wireless network N3 such as a wireless LAN access point 5. Further, an external storage 6 is connected to the body of the projector 2.

The projector 2 performs communications with external apparatuses via the data transmission line or the networks to acquire contents from the external apparatuses. The body of the projector 2 has a serial bus for connecting to the external storage 6 such as a USB (Universal Serial Bus). The projector 2 acquires contents from the external storage 6 via the serial bus.

The projector 2 may be a display apparatus such as a monitor configured to project the contents supplied.

The image output apparatus 4 inputs contents into the projector 2 via an audio-video input terminal such as an HDMI (High-Definition Multimedia Interface)(registered trademark) terminal, a video terminal, or an RGB terminal. The image output apparatus 4 is a TV, a PC or the like having the audio-video input terminal.

The information processing apparatus 3 transmits data to or receive data from the projector 2. The information processing apparatus 3 performs wired or wireless communications.

The access point 5 mediates the data transmission and data reception between the information processing apparatus 3 and the projector 2. The access point 5 may, for example, be the wireless LAN access point 5.

The external storage 6 is a recording medium configured to store contents transmitted from the projector 2. The external storage 6 may be a USB memory.

Note that the number of components forming the display system 1 such as the information processing apparatus 3 and the image output apparatus 4 may be greater than or less than the number of components of the example illustrated in FIG. 1.

### Hardware Configuration

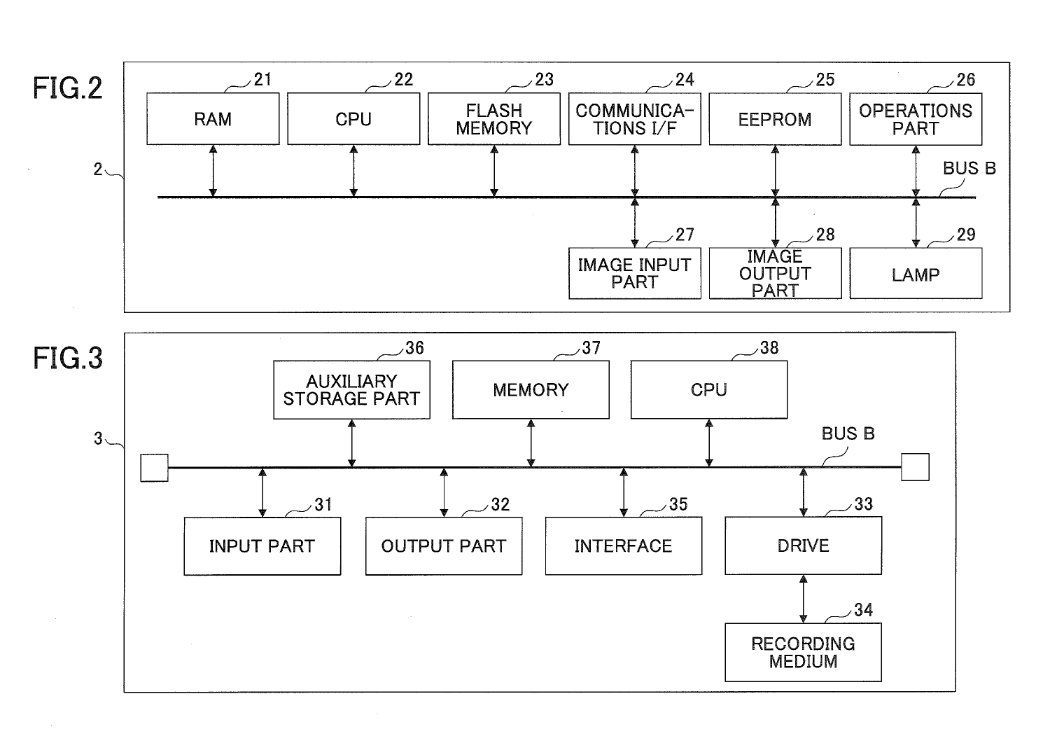

FIG. 2 is a diagram illustrating a hardware configuration example of the projector 2 in the embodiment.

### Projector

The projector 2 includes a RAM (random access memory) 21, a CPU (central processing unit) 22, a flash memory 23, a communications interface (I/F) 24, an EEPROM (electrically erasable programmable read-only memory) 25, an operations part 26, an image input part 27, an image output part 28, and a lamp 29 that are connected to one another via a bus B.

The RAM 21 is configured to store temporarily read programs and data to be executed by the CPU 22. The CPU 22 is configured to execute programs to control the entire apparatus. The flash memory 23 and the EEPROM 25 are configured to store various types of data such as image data and audio (sound-voice) data.

The communications I/F 24 is configured to transmit or receive contents via the data transmission line or the networks. The operations part 26 is configured to receive operations from a user, and perform operations to adjust brightness of images, volume of sound, and the like.

The image input part 27 is configured to receive the contents supplied from the information processing apparatus 3 via the communications I/F 24. The image output part 28 may be a liquid crystal display apparatus, and is configured to output the image data received from the image input part 27. The lamp 29 may be a halogen lamp configured to emit light so as to project the image data on a projection surface such as a hologram screen via a not-illustrated projection lens.

### Information Processing Apparatus

FIG. 3 is a diagram illustrating a hardware configuration example of the information processing apparatus 3 in the embodiment.

The information processing apparatus 3 includes an input part 31, an output part 32, a drive 33, an interface 35, an auxiliary storage part 36, a memory 37, and a CPU 38 that are connected to one another via a bus B. The drive 33 is connected to a recording medium 34.

Note that the image output apparatus 4 may have a hardware configuration similar to that of the information processing apparatus 3.

The input part 31 is composed of a keyboard, a mouse, and the like, and is used to input various types of signals.

The output part 32 may be composed of a display, and used to display various types of windows, data, and the like.

The drive 33 is configured to read data from or write data into the recording medium 34.

The recording medium 34 may be various types of a storage medium including a CD-ROM (Compact Disk Read Only Memory), a magneto-optical disk, and semiconductor memory such as a flash memory.

The interface 35 is composed of a modem, a LAN card, and the like, and is configured to connect the information processing apparatus 3 to the networks.

The auxiliary storage part 36 is composed of a hard disk drive, and is configured to store programs, files, data, and the like necessary for executing processes.

The memory 37 is composed of a semiconductor memory or the like, and is configured to temporarily store programs or information for performing operation processes including arithmetic and logic operations.

The CPU 38 is configured to execute various types of processes in accordance with the programs stored in the memory 37.

When the recording medium 34 storing the programs is set in the drive 33, the programs are installed from the recording medium 34 into the auxiliary storage part 36 via the drive 33. The installation of the programs are, but not limited to, performed by reading the programs from the recording medium 34. The installation of the programs may be performed by downloading the programs via the networks.

The memory 37 is configured to read the programs from the auxiliary storage part 36 in accordance with an activation request from the CPU 38. The CPU 38 is configured to execute various types of operation processes in accordance with the programs stored in the memory 37.

### Functional Configuration

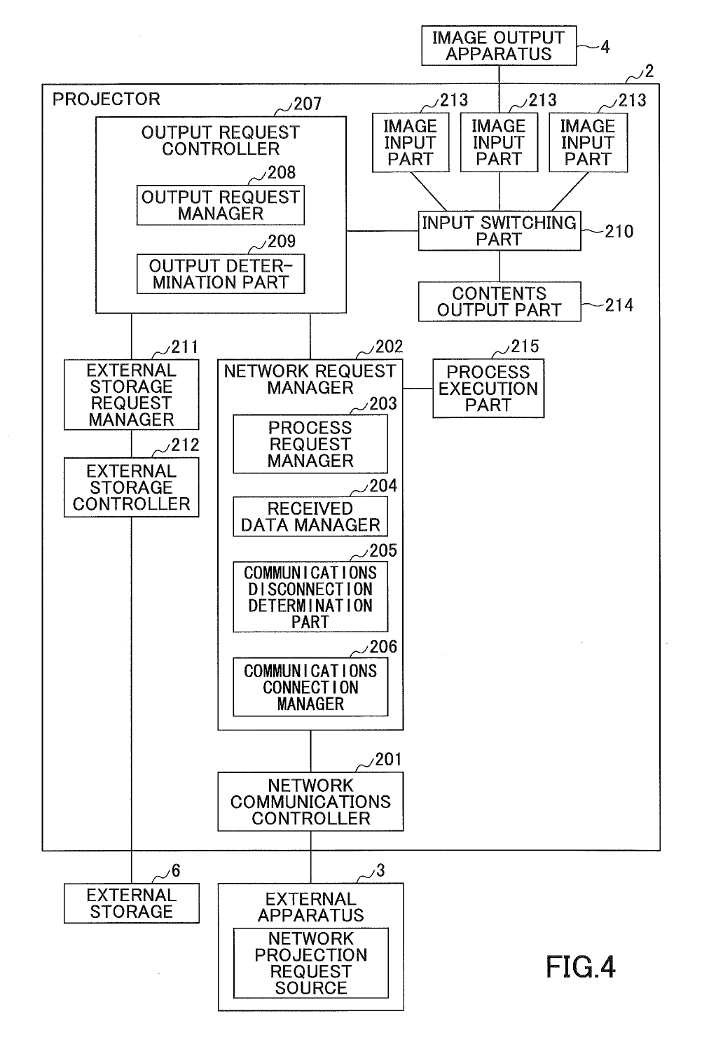

FIG. 4 is a diagram illustrating a functional configuration of the projector 2.

The projector 2 includes a network communications controller 201, a network request manager 202, an output request controller 207, an input switching part 210, an external storage request manager 211, an external storage controller 212, an image input part 213, a contents output part 214, and a process execution part 215. The network request manager 202 includes a process request manager 203, a received data manager 204, a communications disconnection determination part 205, and a communications connection determination manager 206. The output request controller 207 includes an output request manager 208, and an output determination part 209.

The network communications controller 201 is configured to control communications connections such as establishment of communications with the information processing apparatus 3, or disconnection of the communications from the information processing apparatus 3. Further, the network communications controller 201 is configured to disconnect the specified communications in accordance with instructions from the network request manager 202. The network communications controller 201 is configured to perform communications using wired or wireless connections. Further, the network communications controller 201 is configured to perform communications based on telecommunication standards such as DLNA (Digital Living Network Alliance), miracast, and the like.

The network request manager 202 is configured to manage process requests acquired by the communications to request the projector 2 to execute processes. Examples of the received process requests include an output request that requests the projector 2 to output contents such as images or videos, a transmission request that requests the projector 2 to transmit a status of the projector 2, and the like. Such process requests may be managed in a list form.

The process request manager 203 is configured to manage the list of the process requests such as registration, deletion, and updating of the process requests.

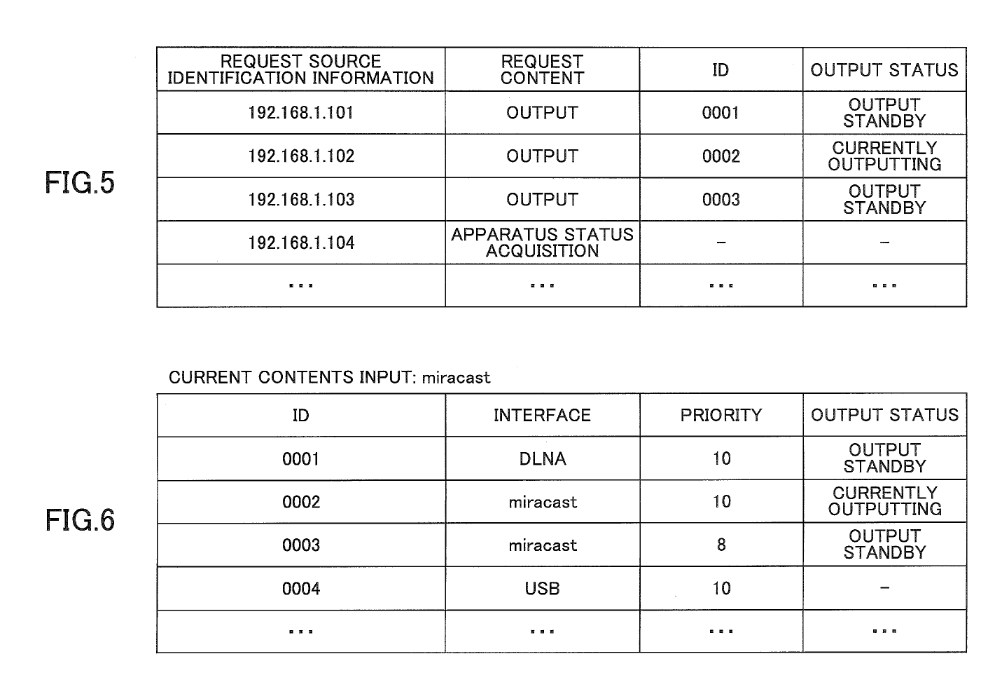

FIG. 5 is a diagram illustrating an example of the list of the process requests managed by the process request manager 203. The list of the process requests includes items of “request source identification information”, a “request content”, an “ID”, and an “output status”.

The “request source identification information” indicates information that identifies a transmission source of a process request. An example of the “request source identification information” includes an IP (Internet Protocol) address as illustrated in FIG. 5. Note that it is preferable that the “request source identification information” be information that uniquely identifies the process request source such as a MAC address.

The “ID” is information for identifying the output request. When receiving the output request, the output request controller 207 issues the “ID”. As illustrated in FIG. 5, the “ID” is a 4 digit number. However, the “ID” may be composed of any characters, symbols, and numbers, or a combination of these that may uniquely identify each of the output requests.

The “request content” is information indicating a process content of the received process request. As illustrated in FIG. 5, the “request content” includes “output” indicating the output request, and “apparatus status acquisition” indicating the transmission request of status information of the projector 2.

The “output status” indicates information illustrating a status of each of the output requests when the output contents are the “output”. The “output status” includes “currently outputting” indicating that the contents are currently being outputted into the contents output part 214, or “output standby” indicating that the contents are in a standby status to be output into the contents output part 214. Values input into the “output status” are determined by the output request controller 207.

When receiving a process request indicating that the request content is the “output”, the process request manager 203 transmits the received process request to the output request manager 208. When receiving a process request indicating that the request content is other than the output request “output”, the process request manager 203 transmits the received process request to the process execution part 215.

Referring back to FIG. 4, the received data manager 204 is configured to manage data associated with the process request received from the information processing apparatus 3. When receiving the contents output from the information processing apparatus 3, the received data manager 204 processes the received contents in accordance with the “output status” on the list of the process requests. For example, when the “output status” is “currently outputting”, the received data manager 204 transmits the received data to the output request controller 207. For example, when the “output status” indicates “output standby”, the received data manager 204 discards the received data. When receiving from the information processing apparatus 3 data for processing an SNMP (Simple Network Management Protocol) or the like, the received data manager 204 transmits the received data to the process execution part 215.

The communications disconnection determination part 205 is configured to determine whether the communications connection needs to be disconnected. The communications disconnection determination part 205 may determine whether the communications connection needs to be disconnected based on the number of communications connections. When the number of communications connections currently connected reaches a predetermined threshold, the communications disconnection determination part 205 transmits an instruction to disconnect a part of the communications connections to the communications connection determination manager 206. Note that the threshold may be a threshold optionally set by a user, or may be held by the projector 2 as an initial value.

The communications connection determination manager 206 disconnects the part of the communications connections in accordance with the instruction from the communications disconnection determination part 205. The communications connection determination manager 206 selects an information processing apparatus 3 to be disconnected in accordance with a level of the priority of the process request received from the information processing apparatus 3. Note that the communications connection determination manager 206 may request the process request manager 203 to delete the process request received from the communications disconnected information processing apparatus 3. Further, the communications may be disconnected from the information processing apparatus 3 from which the contents output part 214 receives the contents.

The timing to disconnect the communications connections may be before or after the contents to be output to the contents output part 214 are determined.

The output request controller 207 is configured to control the output request acquired from the external storage 6 or acquired via the networks.

The output request manager 208 is configured to manage a list of the output requests such as registration, deletion, and updating of the output requests that request output of the contents.

FIG. 6 is a diagram illustrating an example of a list of output requests managed by the output request manager 208. The list of the output requests includes information items such as an “ID”, “priority”, and an “output status”.

The “ID” is information for identifying each of the output requests. The “ID” is issued for each of the received output requests every time the output request manager 208 receives the corresponding output request. In the example of FIG. 1, a number is input as the “ID”. However, the “ID” is not limited to the number, and may be any item insofar as the item may uniquely identify the output requests.

The “interface” is information indicating which interface mediates the reception of the output request. Examples of the “interface” include names of the communications standards such as miracast, DLNA, and the like.

The “priority” indicates information illustrating levels of the priority of the output requests. The contents output part 214 outputs the output requests in the descending order of priority (i.e., from the highest priority). For example, the “priority” may be represented by numbers. In the example of FIG. 6, the number “10” is input as the output request of the highest priority. However, the levels of the “priority” may be represented by items other than the numbers. Further, the information processing apparatus 3 configured to transmit the output request may set the “priority”, or the output request controller 207 may set the “priority”.

The “output status” is information indicating whether the output request is being executed. When the output request is being executed, the “currently outputting” is input as the “output status”. The output request being the “currently outputting” indicates a status in which contents corresponding to the output request are currently transmitted to the contents output part 214. When the output request is not executed, the “output standby” is input as the “output status”. The output request not being executed indicates a status in which the output request manager 208 is in a standby status and does not output the contents corresponding to the output request from the network request manager 202 or the external storage request manager 211.

The output request manager 208 is configured to maintain information on the interface that inputs the contents into the contents output part 214.

The output determination part 209 is configured to select contents to be output by the contents output part 241 among the output requests included in the list of the output requests. For example, the output determination part 209 selects as the contents to be output the contents of the highest priority of the output request among the received output requests. The selected contents are transmitted to the input switching part 210. Note that the contents to be output may be selected by other methods such as selection based on the time at which the output request has been received.

The output determination part 209 is configured to reselect the contents to be output when the interface that inputs the contents into the contents output part 214 is changed. After selecting the contents, the output determination part 209 ends the transmission of the currently output contents. Then, the output determination part 209 transmits newly selected contents to the input switching part 210.

The input switching part 210 is configured to switch between the interfaces that input the contents into the contents output part 214.

Further, the input switching part 210 is configured to manage the interfaces that input the contents into the contents output part 214.

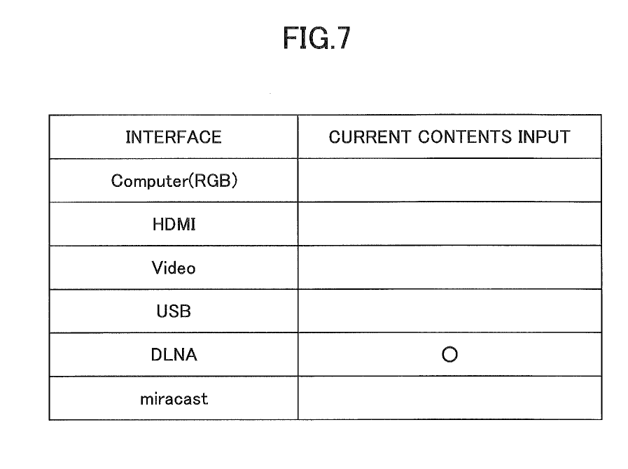

FIG. 7 is a diagram illustrating an example of a management list of the interfaces managed by the input switching part 210. The management list includes information items such as the “interface”, “current contents input”, and the like. The “interface” is information illustrating an interface via which the projector 2 is capable of receiving data. The “interface” may include communications types such as wired communications or wireless communications, or settings of the communications standards such as DLNA, miracast, and the like. The “current contents input” is information indicating the interface that inputs the contents into the contents output part 214. For example, a circle “∘” may be input as the interface that inputs the contents into the contents output part 214, as illustrated in FIG. 7. FIG. 7 illustrates an example indicating that the interface “DLNA” serves as an interface that inputs the contents into the contents output part 214.

Further, the input switching part 210 is configured to provide the output request controller 207 with the information on the interface that inputs the contents into the contents output part 214.

The external storage request manager 211 is configured to transmit the output request having the contents stored in the external storage 6 to the output request controller 207. Further, the external storage request manager 211 is configured to acquire the contents corresponding to the output request having the “output status” being the “currently outputting”, and transmit the acquired contents to the output request controller 207.

The external storage controller 212 is configured to read stored in the external storage 6, and write the contents into the external storage 6.

The image input part 213 is configured to receive input contents from the image output apparatus 4. The image input part 213 is disposed in each of the communications standards of audio-video terminals such as RGB terminals or the HDMI (registered trademark). FIG. 4 illustrates a case where plural image input parts 213 are disposed.

The input contents received by the image input parts 213 are output to the contents output part 214 via the input switching part 210.

The contents output part 214 is configured to output the input contents via the input switching part 210.

The process execution part 215 is configured to control operations of the body of the projector 2. The process execution part 215 is configured to execute the processes received from the network request manager 202.

Having the above-described functions, the projector 2 may be able to manage the number of communications connections connectable to the information processing apparatus 3. Hence, the projector 2 may be able to perform communications with two or more information processing apparatuses 3 without depletion of the number of communications connections.

### Process Operations

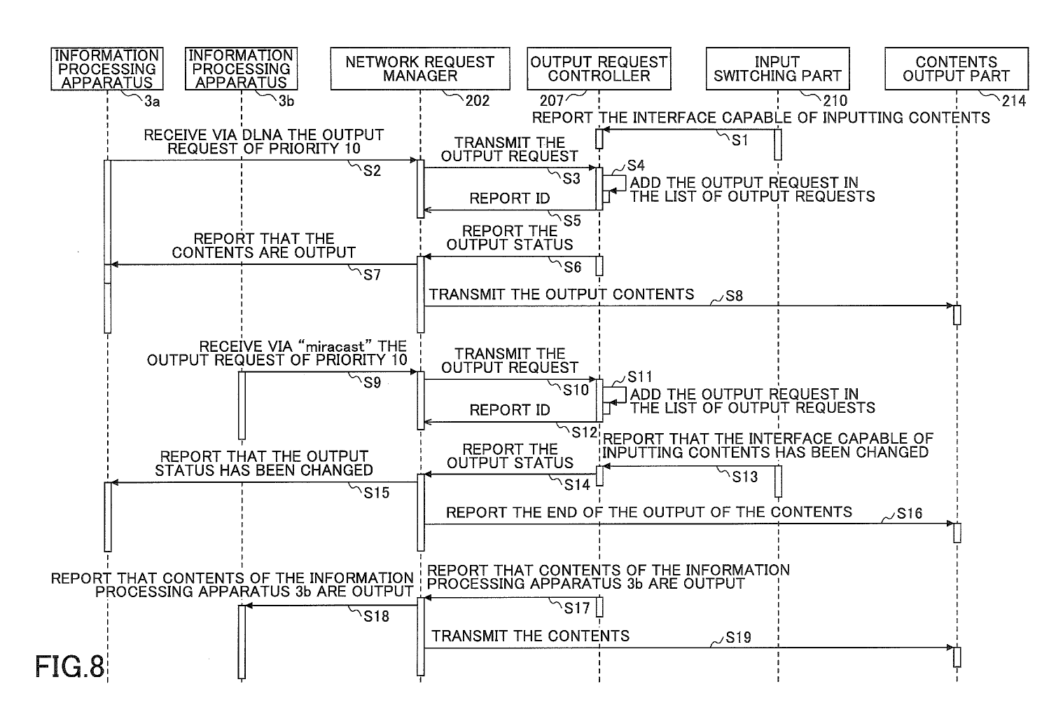

FIG. 8 is a sequence diagram illustrating a process of switching contents to be output along with switching the interface that inputs the contents.

In step 1, the input switching part 210 reports to the output request controller 207 that the interface that inputs the contents into the contents output part 214 is “DLNA”.

In step S2, the network request manager 202 receives the output request of the contents from the information processing apparatus 3a via the interface “DLNA”. Then, the network request manager 202 adds the output request received from the information processing apparatus 3a into the list of the process requests.

In step S3, the network request manager 202 transmits the received output request to the output request controller 207.

In step S4, the output request controller 207 adds the received output request in the list for managing the output requests. Then, the output request controller 207 issues an ID and inputs an output status, corresponding to the added output request.

In step S5, the output request controller 207 reports the ID to the network request manager 202. The network request manager 202 updates the list of process requests based on the reported ID.

In step S6, the output request controller 207 reports the output status indicating “currently outputting” to the network request manager 202. The network request manager 202 updates the list of the process requests based on the reported output status.

In step S7, the network request manager 202 reports to the information processing apparatus 3a that the contents of the information processing apparatus 3a are currently being output into the projector 2.

In step S8, the contents received from the information processing apparatus 3a are transmitted to the contents output part 214.

In step S9, the network request manager 202 receives the output request from the information processing apparatus 3b via the interface “miracast”. The network request manager 202 adds the output request received from the information processing apparatus 3b into the list of the process requests.

In step S10, the network request manager 202 transmits the received output request to the output request controller 207.

In step S11, the output request controller 207 adds the received output request into the list of the output requests. Then, the output request controller 207 issues an ID and inputs an output status, corresponding to the added output request.

In step S12, the output request controller 207 reports the ID to the network request manager 202. The network request manager 202 updates the list of process requests based on the reported ID.

In step S13, the interface that inputs the contents into the contents output part 214 is changed to “miracast”, and the input switching part 210 reports to the output request controller 207 that the interface is changed to “miracast”. The output request controller 207 changes the output status of the output request received from the information processing apparatus 3a to the “output standby” status.

In step S14, the output request controller 207 reports to the network request manager 202 that the output request received from the information processing apparatus 3a has been changed to the “output standby” status. Then, the network request manager 202 discards the contents received from the information processing apparatus 3a without transmitting the received contents to the output request controller 207.

In step S15, the network request manager 202 reports to the information processing apparatus 3a that the output status has been changed to the “output standby” status.

In step S16, the network request manager 202 reports to the contents output part 214 via the output request controller 207, and the input switching part 210 that the output of the contents of the information processing apparatus 3a will end.

In step S17, the output request controller 207 reports to the network request manager 202 that the contents received from the information processing apparatus 3b are output to the projector 2.

In step S18, after updating the information of the output status of the information processing apparatus 3b, the network request manager 202 reports to the information processing apparatus 3b that the contents are output to the projector 2.

In step S19, the network request manager 202 transmits the contents received from the information processing apparatus 3b to the contents output part 214 via the output request controller 207 and the input switching part 210.

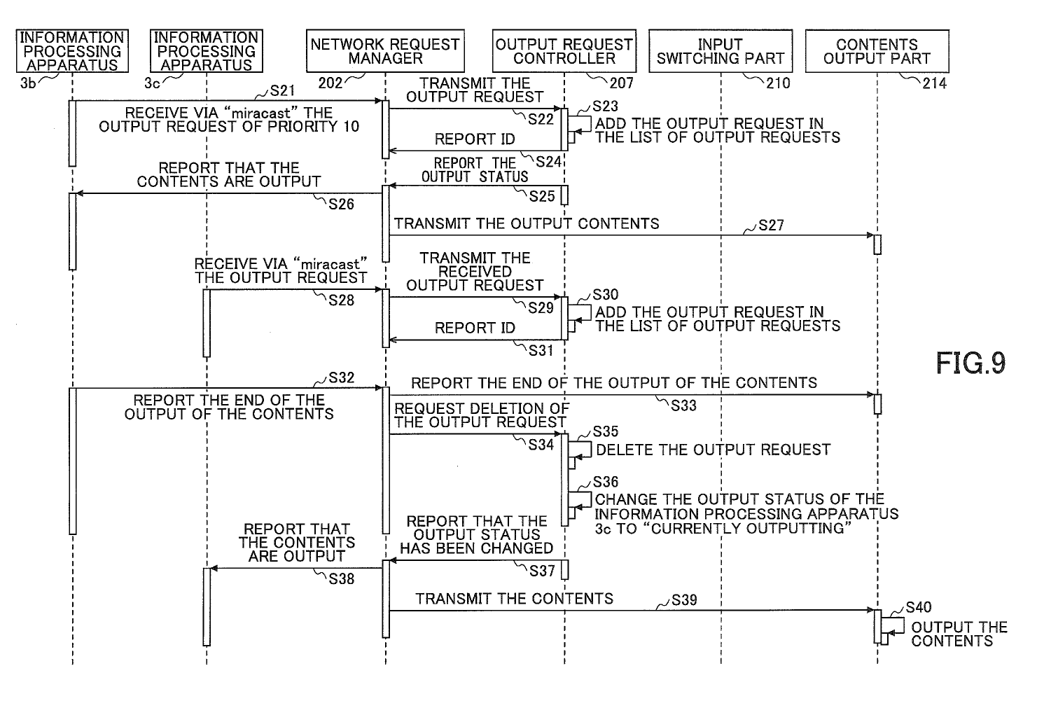

FIG. 9 is a sequence diagram illustrating a process of switching the contents to be output along with ending the output of the contents.

In step S21, the network request manager 202 receives the output request from the information processing apparatus 3b via the interface “miracast”. The network request manager 202 adds the output request received from the information processing apparatus 3b into the list of the process requests.

In step S22, the network request manager 202 transmits the received output request to the output request controller 207.

In step S23, the output request controller 207 adds the received output request into the list of the output requests. Then, the output request controller 207 issues an ID and inputs an output status, corresponding to the added output request.

In step S24, the output request controller 207 reports the ID to the network request manager 202. The network request manager 202 updates the list of process requests based on the reported ID.

In step S25, the output request controller 207 reports the output status indicating “currently outputting” to the network request manager 202. The network request manager 202 updates the list of the process requests based on the reported output status.

In step S26, the network request manager 202 reports to the information processing apparatus 3b that the contents of the information processing apparatus 3b are currently being output into the projector 2.

In step S27, the contents received from the information processing apparatus 3a are transmitted to the contents output part 214.

In step S28, the network request manager 202 receives the output request from the information processing apparatus 3c via the interface “miracast”. The network request manager 202 adds the output request received from the information processing apparatus 3c into the list of the process requests.

In step S29, the network request manager 202 transmits the received output request to the output request controller 207.

In step S30, the output request controller 207 adds the received output request into the list of the output requests. Then, the output request controller 207 issues an ID and inputs an output status, corresponding to the added output request. At this time, since the priority of the output request received from the information processing apparatus 3b is higher than that of the output request received from the information processing apparatus 3c, the output request controller 207 controls the status of the contents received from the information processing apparatus 3c to be the “output standby” status.

In step S31, the output request controller 207 reports the ID to the network request manager 202. The network request manager 202 that has received the report updates the list of the process requests based on the reported information.

In step S32, the network request manager 202 receives a report indicating ending the output of the contents received from the information processing apparatus 3b.

In step S33, the network request manager 202 reports ending the output of the contents received from the information processing apparatus 3b to the contents output part 214 via the output request controller 207 and the input switching part 210.

In step S34, the network request manager 202 deletes from the list of the process requests the process request received from the information processing apparatus 3b. Then, the network request manager 202 requests the output request controller 207 to delete the output request from the list of the output requests.

In step S35, the output request controller 207 deletes the output request received from the information processing apparatus 3b.

In step S36, the output request controller 207 changes the output status of the output request received from the information processing apparatus 3c to “currently outputting”.

In step S37, the output request controller 207 reports to the network request manager 202 that the output status of the output request received from the information processing apparatus 3c has been changed to “currently outputting”.

In step S38, after updating the list of the process requests, the network request manager 202 reports to the information processing apparatus 3c that the contents received from the information processing apparatus 3c are output.

In step S39, the network request manager 202 transmits the contents received from the information processing apparatus 3c to the contents output part 214 via the output request controller 207 and the input switching part 210.

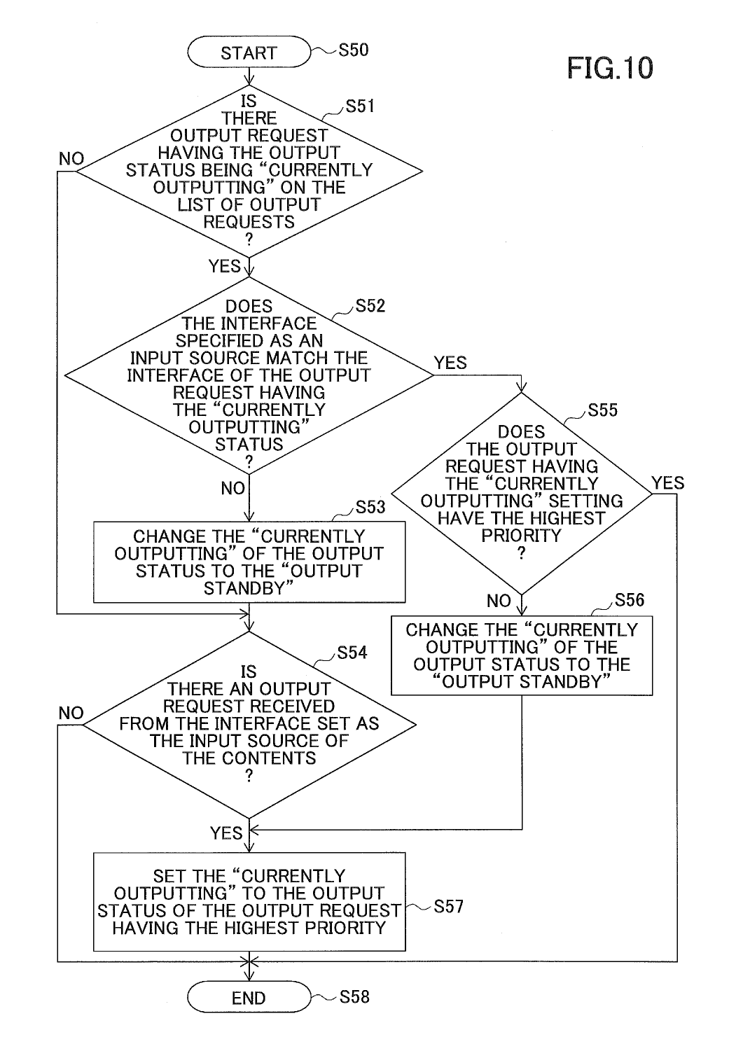

FIG. 10 is a flowchart illustrating a process of determining the output status of the output request.

In step S50, when the interface that inputs the contents into the contents output part 214 is changed, when a new output request is input into the list of the output requests, or when the output of the contents ends, the process of determining the output status of the output request starts.

In step S51, the output request manager 208 determines whether there is an output request having the output status being “currently outputting” on the list of output requests. When the determination is “YES” in step S51, that is, when there is an output request having the output status being “currently outputting” on the list of output requests, the output request manager 208 proceeds with step S52. When the determination is “NO” in step S51, that is, when there is no output request having the output status being “currently outputting” on the list of output requests, the output request manager 208 proceeds with step S54.

In step S52, the output request manager 208 determines whether the interface having the output status setting of “currently outputting” matches the interface that inputs the contents output by the contents output part 214. When the determination is “YES” in step S52, that is, when the two interfaces match, the output request manager 208 proceeds with step S55. When the determination is “NO” in step S52, that is, when the two interfaces do not match, the output request manager 208 proceeds with step S53.

In step S53, the item “currently outputting” of the output status is changed to the item “output standby”. Then, the output request manager 208 reports to the transmission source of the output request that the output status is changed to “output standby”.

In step S54, the output request manager 208 determines whether there is an output request received via the interface set as the input source of the data to the contents output part 214 on the list of the output requests received via the same interface. When the determination is “YES” in step S54, that is, when there is an output request received via the interface set as the input source of the data to the contents output part 214 on the list of the output requests, the output request manager 208 proceeds with step S57. When the determination is “NO” in step S54, that is, when there is no output request received via the interface set as the input source of the data to the contents output part 214 on the list of the output requests, the output request manager 208 proceeds with step S58 to end the determination process.

In step S55, the output request manager 208 determines whether the output request having the “currently outputting” setting has the highest priority among the list of the output requests having the matched “interface” item. When the determination is “YES” in step S55, that is, when the output request having the “currently outputting” setting has the highest priority, the output request manager 208 proceeds with step S58 to end the determination process. When the determination is “NO” in step S55, that is, when the output request having the “currently outputting” setting has the second or lower priority, the output request manager 208 proceeds with step S56.

In step S56, the item “currently outputting” of the output status is changed to the item “output standby”. Then, the output request manager 208 reports to the transmission source of the output request that the output status is changed to “output standby”.

In step S57, the “currently outputting” is input to the item of the output status of the output request having the highest priority among the output requests received via the interface set as the input source of the data to the contents output part 214. Then, the output request manager 208 reports to the information processing apparatus 3 serving as the transmission source of the output request that the output status is changed to “currently outputting”. Subsequently, the contents output part 214 outputs the contents corresponding to the output request, and then the determination process ends.

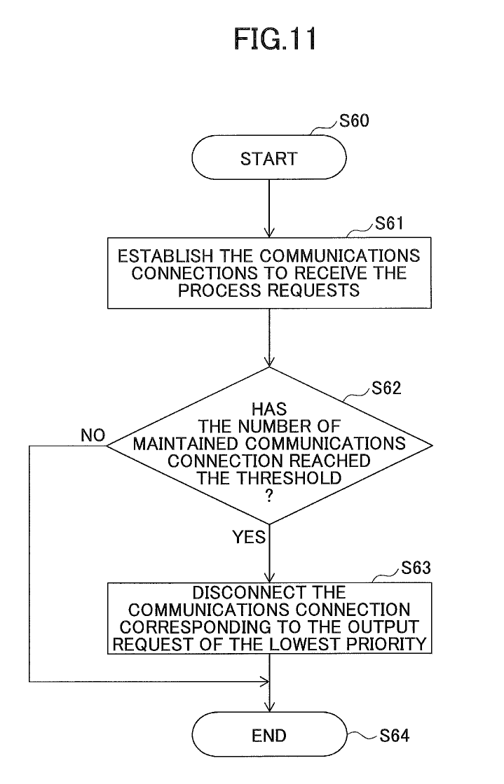

FIG. 11 is a flowchart illustrating a process of disconnecting the communications connections when the number of maintained communications connections reaches the upper limit.

In step 60, the disconnection process starts in a state where the projector 2 has communications connections with predetermined number of terminals.

In step 61, the communication connections are established to receive the process requests.

In step S62, it is determined whether the number of maintained communications connections has reached a threshold. When the determination is “YES”, that is, when the number of maintained communications connections has reached a threshold, step S63 is processed. When the determination is “NO”, that is, when the number of maintained communications connections has not reached the threshold, and the process ends in step S64.

In step S63, the communications connection corresponding to the output request of the lowest priority is disconnected, and the process ends in step S64.

### Modification 1

A modification 1 is an example in which an information item of a “final update time” is added to the information items of the list of the process requests. In the modification 1, an illustration is given of the items and components differing from the above-described embodiment. The items and components identical to those of the above-described embodiment are provided with the same reference numbers, and a duplicated illustration is omitted from the description.

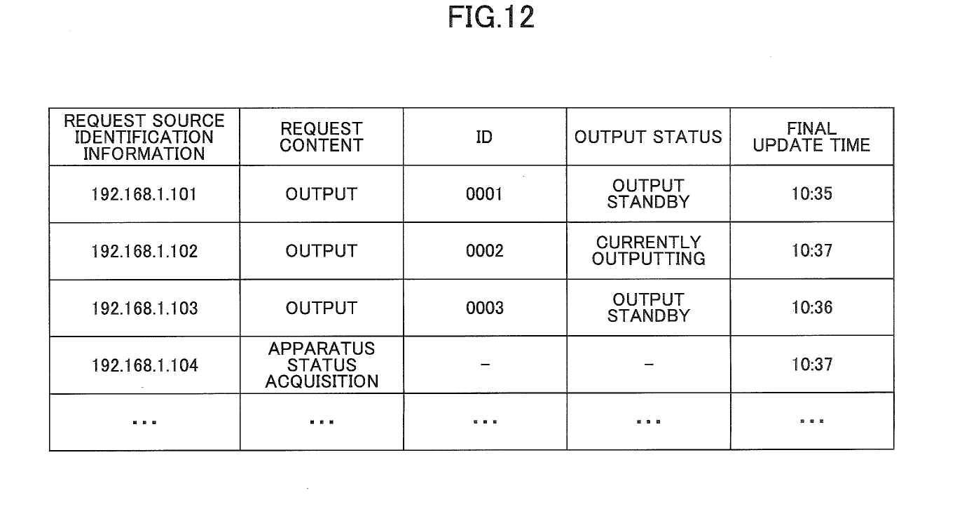

FIG. 12 is a diagram illustrating an example of the list of the process requests in the modification 1. The list of the process requests in FIG. 12 includes the “final update time”.

The “final update time” indicates a time at which each of the contents of the process requests is finally updated, or a time at which the last time data are acquired from the process request source.

When the number of communications connections has reached the upper limit, the communications connection determination manager 206 disconnects a part of the communications connections based on the “final update time”.

### Modification 2

A modification 2 is an example in which a part of the communications connections is disconnected at a predetermined period. In the modification 2, an illustration is given of the items and components differing from the above-described embodiment. The items and components identical to those of the above-described embodiment are provided with the same reference numbers, and a duplicated illustration is omitted from the description.

The communications disconnection determination part 205 includes a timer having a setting of a predetermined value. When the value of the timer reaches a predetermined threshold, the communications disconnection determination part 205 determines that a part of the communications connections needs to be disconnected. The communications connection determination manager 206 selects an information processing apparatus 3 to disconnect its communications connection based on the instructions from the communications disconnection determination part 205. Then, the communications disconnection determination part 205 resets the value of the time to the initial value to restart the timer. The timer may be a count-up type or a count-down type.

Note that the selection of the information terminal (the information processing apparatus) to disconnect its communications connection may be regularly conducted without using the timer.

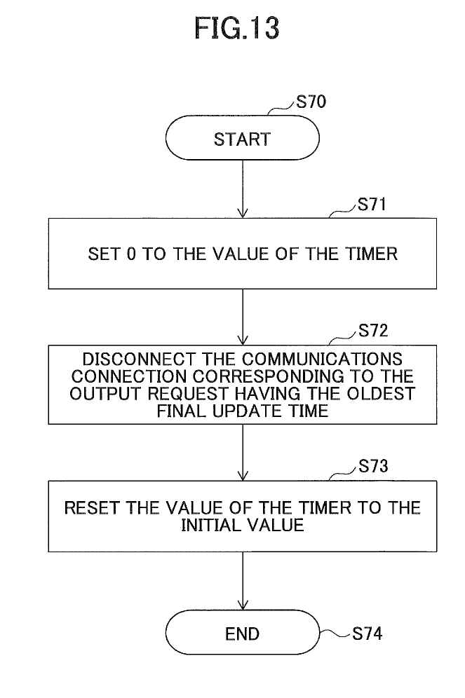

FIG. 13 is a flowchart illustrating a disconnection process when the communications connections in the modification 2 are disconnected.

In step S70, the disconnection process in the modification 2 starts when the timer starts to count down the time.

In step S71, the value of the timer is “0”.

In step S72, the communications connection with the information processing apparatus 3 that transmits the output request having the oldest final update time may be disconnected, for example.

In step S73, the communications disconnection determination part 205 resets the value of the timer to the initial value. Thereafter, the disconnection process ends in step S74.

FIG. 13 illustrates a case where the information processing apparatus 3 from which its communications connection is disconnected is selected based on the final update time. However, the information processing apparatus 3 from which its communications connection is disconnected may be selected based on a level of the priority included in the output request.

### Modification 3

A modification 3 is an example in which the upper limit of the number of the output requests added on the list is determined with respect to the list of the output requests.

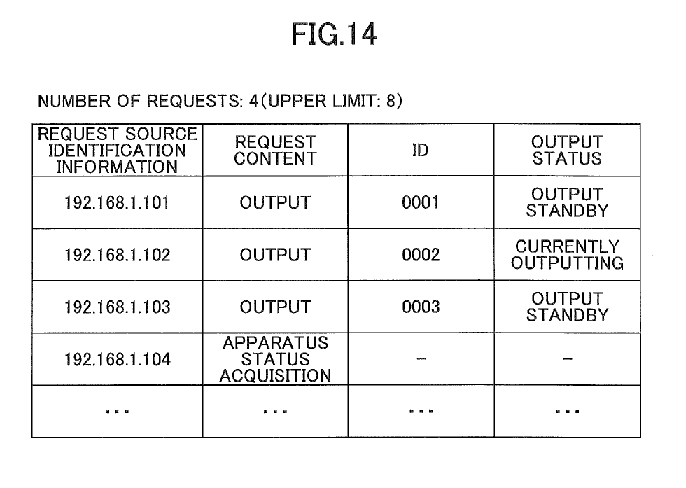

FIG. 14 is an example when the upper limit is provided with respect to the number of the process requests added on the list of the output requests.

As illustrated in FIG. 14, it is preferable that the upper limit of the number of the output requests be the number of the communications connections that may simultaneously be established by the projector 2.

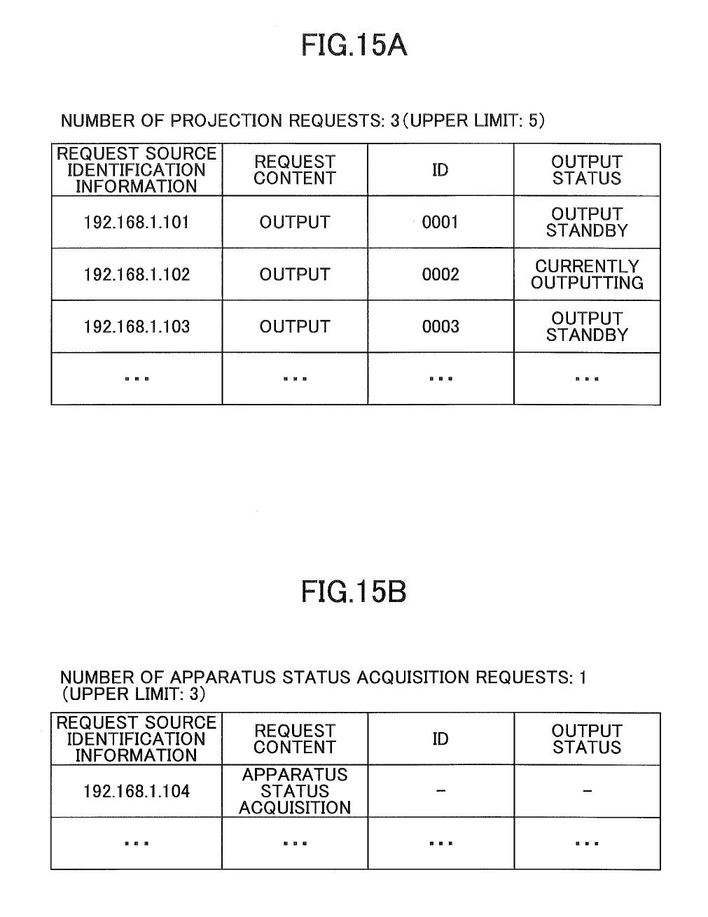

Further, as illustrated in FIGS. 15A and 15B, a list of process requests may be created for each of the request contents, and the upper limit is provided with respect to the number of process requests added on the list for a corresponding one of the request contents. In FIG. 15A, when the request contents are the “output” of the contents, the upper limit of the number of the process requests added on the list of the process requests may, for example, be “5”. Further, in FIG. 15B, when the request contents are that other than the “output” of the contents, the upper limit of the number of the process requests added on the list of the process requests may, for example, be “3”. In this case, it is preferable that a sum of the upper limits of the numbers of the process requests of the respective lists be equal to the upper limit of the number of the communications connections that may simultaneously be stablished by the projector 2.

When the number of the process requests added on the list of the process requests has reached the upper limit, the process request manager 203 selects the process request to be deleted. The process request to be deleted from the list of the process requests may be selected based on the levels of the priority of the process requests, or final update times of the process requests. Further, the process request manager 203 requests the communications connection determination manager 206 to disconnect the communications connection of the information processing apparatus 3 corresponding to the transmission source of the deleted process request.

Note that all of or part of the above-described embodiment and modifications may be implemented by a computer program. The computer program may be stored in a portable recording medium. The portable recording medium indicates a non-transitory recording medium. Examples of the portable recording medium include a magnetic recording medium, an optical disk, a magnetooptical medium, and a non-volatile memory. All of or part of the above-described embodiment and modifications may be implemented by causing a processor to read the computer program stored in the portable recording medium and execute the read computer program.

### Outline

The present invention is described in accordance with a preferred embodiment of the present invention. However, the present invention has been described not limited to these embodiment and modifications, and various corrections or changes may be added without departing from the broad spirit and scope of the invention as defined in the claims. Specifically, the present invention shall not be construed as being limited to details of the specific examples and accompanying drawings thereof.

According to an aspect of the embodiment, it may be possible to perform communications with plural terminals in consideration of the number of the communications connections.

The present invention is not limited to the specifically disclosed embodiments, and variations and modifications may be made without departing from the scope of the present invention.

The present application is based on and claims the benefit of priority of Japanese Priority Application No. 2014-145887 filed on Jul. 16, 2014, the entire contents of which are hereby incorporated herein by reference.

What is claimed is:

1. A display apparatus communicating with a plurality of terminals, the display apparatus and the terminals being connected via a network, the display apparatus comprising:
a communications connection establishing module configured to establish a plurality of communications connections with the terminals;
a selection module configured to select a communications connection from the communications connections;
a display controller configured to control a display based on a request from the selected one of the communications connections;
a determination module configured to determine whether a part of the communications connections needs to be disconnected; and
a communications disconnection module configured to disconnect the part of the communications connections based on a predetermined rule when the determination module determines that the part of the communications connections needs to be disconnected.

2. The display apparatus as claimed in claim 1, wherein
the determination module determines whether a number of the communications connections exceeds a threshold, and when the number of the communications connections exceeds a threshold, the determination module determines that the part of the communications connections needs to be disconnected.

3. The display apparatus as claimed in claim 1, wherein
the determination module determines that the part of the communications connections needs to be disconnected, at a predetermined period.

4. The display apparatus as claimed in claim 1, wherein
the communications disconnection module determines to disconnect the part of the communications connections based on a level of a priority of the request received via the communications connection.

5. The display apparatus as claimed in claim 1, wherein
the communications disconnection module determines to disconnect the part of the communications connections based on a time at which the last time data are received.

6. The display apparatus as claimed in claim 1, wherein
the communications disconnection module deletes a request corresponding to the disconnected communications connection.

7. A non-transitory computer-readable recording medium storing a display program for performing communications between a display apparatus and a plurality of terminals, the display apparatus and the terminals being connected via a network, the display program, which when processed by a processor, causes a computer to perform a process comprising:
establishing a plurality of communications connections with the terminals;
selecting a communications connection from the communications connections;
controlling a display based on a request from the selected one of the communications connections;
determining whether to disconnect a part of the communications connections; and
disconnecting the part of the communications connections based on a predetermined rule when it is determined that the part of the communications connections needs to be disconnected.

8. A display system including a display apparatus and a plurality of terminals, the display apparatus and the terminals being connected via a network, the display system comprising:
a communications connection establishing module configured to establish a plurality of communications connections with the terminals;
a selection module configured to select a communications connection from the communications connections;
a display controller configured to control a display based on a request from the selected one of the communications connections;
a determination module configured to determine whether to disconnect a part of the communications connections; and
a communications disconnection module configured to disconnect the part of the communications connections based on a predetermined rule when the determination module determines that the part of the communications connections needs to be disconnected.
